(19) United States
(12) Patent Application Publication
(10) Pub. No.: US 2018/0306280 A1
(43) Pub. Date: Oct. 25, 2018

(54) Planetary Power-Shift Multi-Stage Transmission, in Particular for an Internal Combustion Engine and/or Electric Motor Drive of a Motor Vehicle

(71) Applicant: ZF Friedrichshafen AG, Friedrichshafen (DE)

(72) Inventors: Stefan Beck, Eriskirch (DE); Marc Seeberger, Oberteuringen (DE); Michael Wechs, Weißensberg (DE); Wolfgang Rieger, Friedrichshafen (DE)

(21) Appl. No.: 15/768,717

(22) PCT Filed: Oct. 4, 2016
(86) PCT No.: PCT/EP2016/073603

§ 371 Date: Apr. 16, 2018

(30) Foreign Application Priority Data
Oct. 23, 2015 (DE) 10 2015 220 753.6

(51) Int. Cl. F16H 3/66; B60K 6/485; B60K 6/365

(52) U.S. Cl. CPC F16H 3/666; F16H 2003/447; B60K 6/365; B60K 6/485

(57) ABSTRACT

A powershift-capable multi-stage transmission having multiple forward gear ratios and one reverse gear ratio, a drive shaft (1), an output shaft (2), two planetary gear sets (RS1, RS2) which are coupled or coupleable to one another and which have at least one first, second, and third transmission element (1.1, 2.1; 1.2, 2.2; 1.3, 2.3), and multiple shift elements (10, 20, 30, 40, 50, 60, 70) which are assigned to the planetary gear sets (RS1, RS2) and selective shifting of which gives rise to a transmission ratio between the drive shaft (1) and the output shaft (2). At least three of the shift elements (10, 20, 30, 40, 50, 60, 70) are brakes by which the first, second, or third transmission element (1.1, 2.1; 1.2, 2.2; 1.3, 2.3) of the planetary gear sets (RS1, RS2) can be braked directly or indirectly against a component (G) fixed with respect to a housing.

### FIELD OF THE INVENTION

The invention relates generally to a powershift-capable multi-stage transmission of planetary design, particularly for a combustion-engine-powered and/or electric-motor-powered drive of a motor vehicle.

### BACKGROUND

A multi-stage transmission of planetary design is also referred to as an automatic transmission or automated transmission. It is used for example in the drive train of motor vehicles, and permits automated engagement of gear ratios.

In motor vehicles, such multi-stage transmissions have hitherto been used primarily in the premium segment. Multi-stage transmissions nowadays have a relatively large number of gear ratio stages in order to satisfy the demand for reduced CO2 emissions of the motor vehicle. Multi-stage transmissions therefore take up a relatively large amount of space. Also, the underlying transmission concepts are thus relatively complex and are therefore elaborate and expensive.

### SUMMARY OF THE INVENTION

The object of the invention is to provide a multi-stage transmission of the type mentioned in the introduction which is of compact construction, is easy to control and is realizable easily and inexpensively, for example, in order to be used in small and/or compact vehicles.

In one embodiment of the invention, a powershift-capable multi-stage transmission of planetary design is provided, having gear ratio stages for multiple forward gear ratios and one reverse gear ratio, in particular mechanical gear ratio stages. The multi-stage transmission is suitable in particular for a combustion-engine-powered and/or electric-motor-powered drive, for example of a motor vehicle. The multi-stage transmission is, for example, designed for connection to a combustion engine and/or an electric machine. The multi-stage transmission may thus be part of a purely combustion-engine-powered drive or of a purely electric-motor-powered drive, or may be the transmission of a hybrid drive.

The multi-stage transmission has a drive shaft as first shaft and has an output shaft as second shaft. Furthermore, the multi-stage transmission has two planetary gear sets which are coupled or coupleable to one another and which have in each case at least one first transmission element, one second transmission element and one third transmission element. The multi-stage transmission furthermore has multiple shift elements which are assigned to the planetary gear sets and the selective shifting of which gives rise to a transmission ratio, corresponding to the respective gear ratio stages, between the drive shaft and the output shaft.

The multi-stage transmission has a simple construction owing to the fact that only the two planetary gear sets are provided for the gear ratio stages. The planetary gear sets themselves furthermore permit a compact design of the transmission.

It is furthermore provided that at least three of the shift elements are brakes by which the first transmission element or the second transmission element or the third transmission element of the planetary gear sets can be braked directly or indirectly, for example via at least one intermediate element, against a component fixed with respect to a housing. In particular, one of the transmission elements of the planetary gear sets can be braked directly or indirectly, in each case, by at least one of the shift elements that are brakes.

In this way, at least these shift elements are controllable in a simple manner in terms of construction and technology, because lines conducting operating medium for the actuation of said shift elements can be arranged so as to originate from the housing. The operating medium lines can thus be at least partially led out of the housing of the multi-stage transmission over a short distance. Also, the operating medium supply for the shift element is thus easily accessible from the outside. Furthermore, owing to the relatively high number of shift elements being brakes, the multi-stage transmission is realizable relatively compactly with regard to structural space, at least in an axial direction.

The component fixed with respect to a housing may be a part of the housing of the multi-stage transmission, for example by being integrally formed on the housing. The component fixed with respect to a housing may also be a separate component which is connected fixedly, for example detachably connected, to the housing of the multi-stage transmission.

According to one alternative or one embodiment of the invention, it is provided that at least two of the shift elements are positively locking shift elements, particularly dog-clutch shift elements. The shift element is thus realizable relatively inexpensively. Furthermore, positively locking shift elements can be relatively compact, for example if the shift elements are dog-clutch shift elements and, for example, if relatively small diameters are usable. A compact construction of the multi-stage transmission is thus possible at least in an axial direction, in particular if it is sought for the multi-stage transmission to be constructed with a relatively small diameter.

By at least some of the shift elements being positively locking shift elements and/or brakes, a high degree of powershift capability is realized in the case of the only two planetary gear stages provided for the gear ratio stages. Furthermore, an optimum transmission ratio is realizable for the respective gear ratio stage, such that an altogether relatively harmonious transmission ratio series is realized.

It may be provided that at least one of the positively locking shift elements is a brake by which the first transmission element or the second transmission element or the third transmission element of the planetary gear sets can be braked directly or indirectly against the component fixed with respect to a housing. This measure also has the aim of realizing the multi-stage transmission in the most compact and technically simple manner possible.

As an alternative to being a positively locking shift element, the at least two shift elements may be frictionally locking shift elements which are, however, not capable of friction work, particularly to thereby withstand low dynamic loads. Such a shift element may be a belt brake or a dry clutch or similar shift element, for example, in which a steel-on-steel friction pairing is placed into operative contact. This, too, promotes a compact design of the multi-stage transmission.

According to a further embodiment of the invention, it is provided that, in the gear ratio stages, in each case, three of the shift elements are closed. Owing to the relatively high number of simultaneously closed shift elements, it is achieved that the multi-stage transmission has a higher transmission efficiency.

One possible mechanical construction of the multi-stage transmission consists in that, with regard to the first planetary gear set, the first transmission element is connected rotationally fixedly to a third shaft, the second transmission element is connected rotationally fixedly to the drive shaft and the third transmission element is connected rotationally fixedly to a fourth shaft, and with regard to the second planetary gear set, the first transmission element is connected rotationally fixedly to a fifth shaft, the second transmission element is connected rotationally fixedly to the fourth shaft and the third transmission element is connected rotationally fixedly to a sixth shaft. In this way, a mechanically relatively simple system construction with the only two planetary gear sets is realized.

In one embodiment of the invention, one possible connection configuration of the components of the multi-stage transmission may be realized such that the third shaft is operatively connectable by a first shift element, the fourth shaft is operatively connectable by a second shift element, and the sixth shaft is operatively connectable by a third shift element in each case to the component fixed with respect to a housing or to a component fixed with respect to a housing. For example, the first shift element, the second shift element and the third shift element form the above-described shift elements that are brakes.

In this possible connection configuration, it is expedient that the drive shaft is operatively connectable, in particular rotationally fixedly connectable, by a fourth shift element to the fifth shaft, the output shaft is operatively connectable, in particular rotationally fixedly connectable, by a fifth shift element to the fourth shaft and/or by a sixth shift element to the sixth shaft, and the third shaft is operatively connectable, in particular rotationally fixedly connectable, by a seventh shift element to the fifth shaft. The fourth shift element, the fifth shift element, the sixth shift element and the seventh shift element thus act relative to rotatable components, and thereby serve as clutches.

By such a connection configuration and arrangement of the shift elements, it is possible for six forward gear ratios, in particular mechanical forward gear ratios, to be selectively engaged. It is also thereby possible for one reverse gear ratio, in particular mechanical reverse gear ratio, to be selectively engaged.

In one possible embodiment of the invention, the selectively engageable forward gear ratios are realized in that the third shift element, the fourth shift element and the fifth shift element are closed in a first forward gear ratio, the third shift element, the fifth shift element and the seventh shift element are closed in a second forward gear ratio, the fourth shift element, the fifth shift element and the seventh shift element are closed in a third forward gear ratio, the first shift element, the fourth shift element and the fifth shift element are closed in a fourth forward gear ratio, the first shift element, the fourth shift element and the sixth shift element are closed in a fifth forward gear ratio, and the first shift element, the sixth shift element and the seventh shift element are closed in a sixth forward gear ratio. The gear ratio stages for forward travel can thus be realized with a harmonious transmission ratio series. Furthermore, a high level of driving comfort with low fuel consumption and high drive power are achievable. For example, the third forward gear ratio is a direct gear ratio.

According to a further embodiment of the invention, the selectively engageable reverse gear ratio is realized in that, in the reverse gear ratio, the second shift element, the fourth shift element and the sixth shift element are closed. In this way, the reverse gear ratio is realizable with a transmission ratio which is suitable for the use of the multi-stage transmission in small and/or compact vehicles.

According to a further embodiment of the invention, it is provided that the second shift element and/or the third shift element and/or the fifth shift element are/is positively locking shift element(s), in particular dog-clutch shift element(s). For example, the above-described shift elements that are brakes are formed at least by the second shift element and/or the third shift element and/or the fifth shift element. In this way, the shift element is realizable relatively inexpensively. Furthermore, positively locking shift elements can be relatively compact, for example if the shift elements are dog-clutch shift elements and, for example, if relatively small diameters are realizable.

Alternatively, the second shift element and/or the third shift element and/or the fifth shift element may be frictionally locking shift elements which are, however, not capable of friction work, in particular, in order to thereby withstand low dynamic loads. Such a shift element may be a belt brake or a dry clutch or similar shift element, for example in which a steel-on-steel friction pairing is placed into operative contact. This, too, promotes a compact design of the multi-stage transmission.

It may be provided that the second shift element and the third shift element are constituent parts of a common positively locking double shift element. Alternatively, the second shift element and the fifth shift element may be constituent parts of a common positively locking double shift element.

It may furthermore be provided that the double shift element has a neutral position in which both individual shift elements are open. The double shift element then has, for example, three shift positions, a first shift position for the closure of one shift element, a second shift position for the closure of the other shift element, wherein the previous shift element is opened again, and a third shift position, which is the neutral position. In this way, this measure also has the aim of realizing as compact a design as possible of the multi-stage transmission. By the reduction to a double shift element, at least one separate shift element is eliminated.

In a further embodiment of the invention, it is provided that the planetary gear sets are minus transmissions, in particular, in each case, a minus transmission or minus planetary gear set. It may be provided that the first transmission element is a sun gear, the second transmission element is a planet gear carrier, particularly a carrier, and the third transmission element is a ring gear.

In a further embodiment of the invention, at least one of the planetary gear sets is a plus transmission or plus planetary gear set. In relation to the embodiment as a minus transmission, the value as a fixed carrier transmission ratio is increased by one. In technical terms, in the multi-stage transmission, the second planetary gear set may be a plus transmission. For example, the plus planetary gear set is realized by virtue of the first transmission element being a sun gear, the second transmission element being a ring gear, and the third transmission element being a planet gear carrier, in particular a carrier. The remaining planetary gear set is then a minus transmission, in which the first transmission element is a sun gear, the second transmission element is a planet gear carrier and the third transmission element is a ring gear.

In one embodiment of the invention, it is provided that the drive shaft or the first shaft and the output shaft or the second shaft are situated coaxially with respect to one another. In this way, the multi-stage transmission is suitable for installation in a vehicle in which the drive train runs in the vehicle longitudinal direction.

Such a coaxial arrangement of drive shaft and output shaft is easily realizable if, according to one embodiment of the invention, the drive shaft provided at the transmission input side, or transmission input shaft, is designed for rotationally fixed connection to an output shaft of an engine, and the output shaft provided at the transmission output side, or transmission output shaft, is designed for rotationally fixed connection to a drivetrain of a motor vehicle, and, in an axial direction with respect to the transmission input shaft and proceeding from the transmission input shaft, the sequence second planetary gear set, first planetary gear set is provided.

To realize an arrangement which is suitable for front-transverse installation or rear-transverse installation in a vehicle, the drive shaft and the output shaft may be situated with an axial offset with respect to one another. For this purpose, it is expedient for the drive shaft provided at the transmission input side, or transmission input shaft, to be designed for rotationally fixed connection to an output shaft of an engine, and for the output shaft provided at the transmission output side, or transmission output shaft, to be designed for rotationally fixed connection to a drivetrain of a motor vehicle, and, in an axial direction with respect to the transmission input shaft and proceeding from the transmission input shaft, for the sequence first planetary gear set, second planetary gear set to be provided.

Both in the case of a coaxial arrangement of drive shaft and output shaft and in the case of an axially offset arrangement of drive shaft and output shaft, it is expedient for at least one shaft of the third shaft, the fourth shaft, the fifth shaft and the sixth shaft to be arranged coaxially with respect to the drive shaft. In this way, a compact construction is realized for a drivetrain running in a vehicle longitudinal direction.

According to a further embodiment of the invention, a launch element is provided. Launching of a motor vehicle is thereby facilitated. Provision may be made for the launch element to be separate and to be positioned, for example, upstream of the planetary gear sets. The launch element may for this purpose be, or have, a torque converter, a dry clutch or a wet clutch.

It may alternatively be provided that one of the shift elements of the multi-stage transmission is usable as a launch element. In this way, an additional launch element can be omitted, which yields advantages with regard to costs and structural space requirement. It is expedient for the shift element that is usable as a launch element to be a frictionally locking shift element, in particular a friction clutch. It may for example be provided that the fourth shift element is usable as a launch element. This is expedient because the fourth shift element is closed, or is closable, for the first forward gear ratio. The same applies for the reverse gear ratio.

According to a further embodiment of the invention, it is provided that the third shaft or the fourth shaft or the fifth shaft or the sixth shaft is usable as a further drive shaft, which is for example operatively connectable by a separating clutch to a further drive. The further drive may be an electric machine. A hybrid drive is thus realizable in a technically simple manner by the multi-stage transmission.

The further drive shaft may also be the drive shaft itself. If, for example, the drive shaft is operatively connectable by a separating clutch to a combustion engine, and an electric machine is provided as a further drive, the further drive or the electric machine is driven concurrently when the combustion engine is coupled to the drive shaft by a separating clutch.

A further embodiment of the invention consists in that a rotary vibration decoupling unit is provided, which is positioned upstream of the planetary gear sets. Rotary vibration decoupling of the drive from the drivetrain of a motor vehicle can thus be easily realized.

The invention proposes a multi-stage transmission which has a simple construction and relatively few mechanical components and which requires only two planetary gear sets for a total of seven gear ratio stages. For this purpose, seven shift elements may be provided, of which three shift elements are engaged per gear ratio stage. The multi-stage transmission has a good transmission ratio series, good toothing efficiency with low transmission losses, and low component loading.

### BRIEF DESCRIPTION OF THE DRAWINGS

Exemplary embodiments of the invention are described in detail in the following drawings. All of the described features and/or features illustrated in the figures form the subject matter of the present invention individually or in any meaningful combination, even independently of the combination thereof in the claims or the back-references thereof. Components that are the same or similar are labeled using the same reference characters. In the drawings, the following is shown:

FIG. 1 shows an embodiment of a powershift-capable multi-stage transmission, for example for a combustion-engine-powered drive of a motor vehicle, with two minus planetary gear sets and with an output shaft, situated coaxially with respect to the drive shaft, in a schematic illustration,

FIG. 2 is a table showing an overview of possible gear ratios that is engageable by the multi-stage transmission according to FIG. 1, and the shift elements that have to be actuated for these,

FIG. 3 shows a further embodiment of a powershift-capable multi-stage transmission, for example for a combustion-engine-powered drive of a motor vehicle, with two minus planetary gear sets and with an output shaft, arranged axially offset with respect to a drive shaft, in a schematic illustration, and

FIG. 4 shows a modification of the multi-stage transmission according to FIG. 3, in which the second planetary gear set is a plus planetary gear set, in a schematic illustration.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

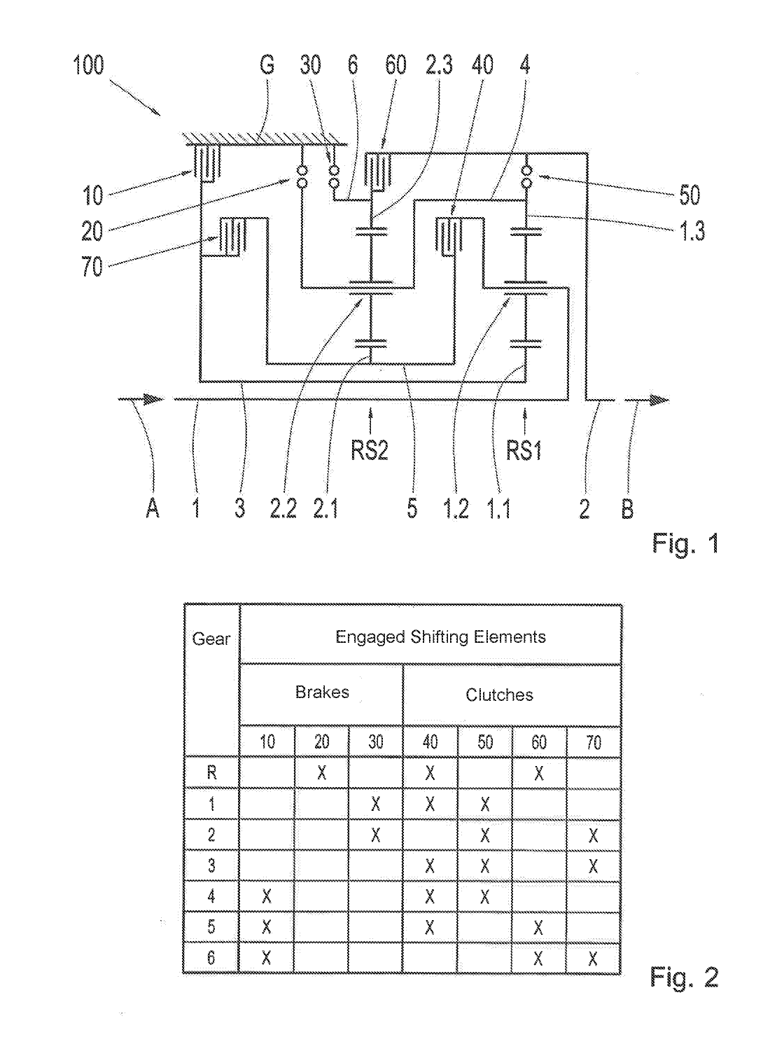

FIG. 1 shows—in a schematic illustration—a possible embodiment of a powershift-capable multi-stage transmission 100, which may be used for example in a drivetrain of a motor vehicle. The multi-stage transmission 100 has a drive shaft 1 as first shaft and an output shaft 2 as second shaft. The drive shaft 1 is arranged at the transmission input side and is a transmission input shaft. The output shaft 2 is arranged at the transmission output side and is a transmission output shaft.

The drive shaft 1 may be connected in terms of drive or connectable in terms of drive to a drive machine (not illustrated in FIG. 1), such as a combustion engine or an electric machine, for example may be rotationally fixedly connected to an output shaft of the drive machine. The drive machine may also have a hybrid drive with a combustion engine and an electric machine, wherein the combustion engine and the electric machine are connectable in terms of drive to the drive shaft 1. The direction of action, resulting from the coupling of the drive machine to the drive shaft 1, for the power flow introduced into the multi-stage transmission 100 and the power flow emerging from the multi-stage transmission 100 is indicated by the arrows A and B.

The multi-stage transmission 100 is of planetary design with only two planetary gear sets, and has a first planetary gear set RS1 and a second planetary gear set RS2, which may, for example, be arranged within a common housing. Each planetary gear set RS1 and RS2 has a first transmission element 1.1 and 2.1 respectively, a second transmission element 1.2 and 2.2 respectively, and a third transmission element 1.3 and 2.3 respectively.

The multi-stage transmission 100 has seven, preferably a total of seven, shift elements, specifically a first shift element 10, a second shift element 20, a third shift element 30, a fourth shift element 40, a fifth shift element 50, a sixth shift element 60 and a seventh shift element 70, the selective shifting of which gives rise to a transmission ratio, corresponding to the respective gear ratio stages, between the drive shaft 1 and the output shaft 2. The shift elements 10, 20, 30, 40, 50, 60 and 70 and the planetary gear sets RS1 and RS2 are arranged relative to one another in the following manner.

With regard to the first planetary gear set RS1, the first transmission element 1.1 is connected rotationally fixedly to a third shaft 3, the second transmission element 1.2 is connected rotationally fixedly to the drive shaft 1, and the third transmission element 1.3 is connected rotationally fixedly to a fourth shaft 4. With regard to the second planetary gear set RS2, the first transmission element 2.1 is connected rotationally fixedly to a fifth shaft 5, the second transmission element 2.2 is connected rotationally fixedly to the fourth shaft 4, and the third transmission element 2.3 is connected rotationally fixedly to a sixth shaft 6.

To realize the seven gear ratio stages, three of the shift elements 10, 20, 30, 40, 50, 60, 70, specifically the first shift element 10, the second shift element 20 and the third shift element 30 are brakes, by which the first transmission element 1.1 or 2.1 or the second transmission element 1.2 or 2.2 or the third transmission element 1.3 or 2.3 of the planetary gear sets RS1 and RS2 respectively can be braked directly or indirectly against a component G fixed with respect to a housing. For this purpose, the third shaft 3 is operatively connectable, in particular rotationally fixedly connectable, by the first shift element 10, the fourth shaft 4 is operatively connectable, in particular rotationally fixedly connectable, by the second shift element 20 and the sixth shaft 6 is operatively connectable, in particular rotationally fixedly connectable, by the third shift element 30 in each case to the component G fixed with respect to a housing or to a component fixed with respect to a housing. The component G fixed with respect to a housing is a component connected fixedly to the housing of the multi-stage transmission, or is an integral constituent part of the housing itself.

Furthermore, the drive shaft 1 is operatively connectable, in particular rotationally fixedly connectable, by the fourth shift element 40 to the fifth shaft 5, the output shaft 2 is operatively connectable, in particular rotationally fixedly connectable, by a fifth shift element 50 to the fourth shaft 4 or by the sixth shift element 60 to the sixth shaft 6. Furthermore, the third shaft 3 is operatively connectable, in particular rotationally fixedly connectable, by the seventh shift element 70 to the fifth shaft 5. The fourth shift element 40, the fifth shift element 50, the sixth shift element 60 and the seventh shift element 70 thus each act relative to rotatable components, and thus serve as clutches.

The second shift element 20 and/or the third shift element 30 and/or the fifth shift element 50 are preferably positively locking shift elements, for example dog-clutches, or shift elements subjected to low dynamic load, such as, for example, belt brakes. As a shift element subjected to low dynamic load, basically any frictionally locking shift element is possible which is not capable of friction work.

In this respect, the shift element may also be a dry clutch which has, for example, a steel-on-steel friction pairing.

The second shift element 20 and the third shift element 30 may be a common double shift element. By actuating the double shift element, either the second shift element 20 can be closed or the third shift element 30 can be closed. The double shift element preferably also has a neutral position in which then neither the second shift element nor the third shift element 30 is closed.

Furthermore, the second shift element 20 and the fifth shift element 50 may be realized in one common double shift element. This double shift element may also have a neutral position such that, in a first position, the second shift element 20 is closed and the fifth shift element 50 is still open, in a second shift position, the second shift element 20 is open and the fifth shift element 50 is closed, and in a third shift position, specifically the neutral position, the second shift element 20 and the fifth shift element 50 are open.

The fourth shift element 40 may be utilized as a launch element. Alternatively, an additional launch element, for example a torque converter, a dry clutch or a wet clutch, may be separately provided, which is positioned upstream of the planetary gear sets RS1, RS2. Provision may furthermore be made for a hybrid head to be positioned upstream of the planetary gear sets RS1 and RS2, which hybrid head is operatively connectable for example by a separating clutch to one of the planetary gear sets RS1 and RS2. The hybrid head may be provided by an electric machine or some other drive other than a combustion engine.

In the embodiment of the multi-stage transmission 100 as per FIG. 1, the first planetary gear set RS1 and the second planetary gear set RS2 are minus transmissions. For this purpose, in each case, the first transmission element 1.1 or 2.1 is a sun gear, the second transmission element 1.2 or 2.2 is a planet gear carrier, particularly a carrier, and the third transmission element 1.3 or 2.3 is a ring gear.

Furthermore, the multi-state transmission 100 is suitable for a drivetrain running continuously in a vehicle longitudinal direction. For this purpose, the drive shaft 1 and the output shaft 2 are arranged coaxially with respect to one another. The arrangement of the planetary gear sets RS1 and RS2 relative to one another is preferably such that, in an axial direction with respect to the drive shaft 1 and proceeding from the drive shaft 1, the sequence second planetary gear set RS2, first planetary gear set RS1 is provided.

FIG. 2 is a table showing an overview of possible gear ratios that are selectively engageable with the multi-stage transmission 100, and showing the shift combinations to be implemented for this purpose with regard to the first shift element 10, the second shift element 20, the third shift element 30, the fourth shift element 40, the fifth shift element 50, the sixth shift element 60 and the seventh shift element 70. According thereto, of the seven available gear ratio stages, six gear ratio stages as forward gear ratios and one gear ratio stage as reverse gear ratio are selectively engageable.

The gear ratios or gear ratio stages are specified in the first column of the overview. The forward gear ratios are denoted by “1”, “2”, “3”, “4”, “5”, “6” and the reverse gear ratio is denoted by “R”. In following columns, the positions of the first shift element 10, of the second shift element 20, of the third shift element 30, of the fourth shift element 40, of the fifth shift element 50, of the sixth shift element 60 and of the seventh shift element 70 associated with each gear ratio are indicated, wherein each shift element 10 and 20 and 30 and 40 and 50 and 60 and 70 is assigned a separate column. Crosses indicate that the respectively associated shift element 10 or 20 or 30 or 40 or 50 or 60 or 70 is present in a closed shift position.

As can be seen from FIG. 2, in each case, three shift elements are closed in a respective gear ratio stage. The first forward gear ratio is engaged by closing the third shift element 30, the fourth shift element 40 and the fifth shift element 50, the second forward gear ratio is engaged by closing the third shift element 30, the fifth shift element 50 and the seventh shift element 70, the third forward gear ratio is engaged by closing the fourth shift element 40, the fifth shift element 50 and the seventh shift element 70, the fourth forward gear ratio is engaged by closing the first shift element 10, the fourth shift element 40 and the fifth shift element 50, the fifth forward gear ratio is engaged by closing the first shift element 10, the fourth shift element 40 and the sixth shift element 60, and the sixth forward gear ratio is engaged by closing the first shift element 10, the sixth shift element 60 and the seventh shift element 70. The reverse gear ratio is engaged by closing the second shift element 20, the fourth shift element 40 and the sixth shift element 60.

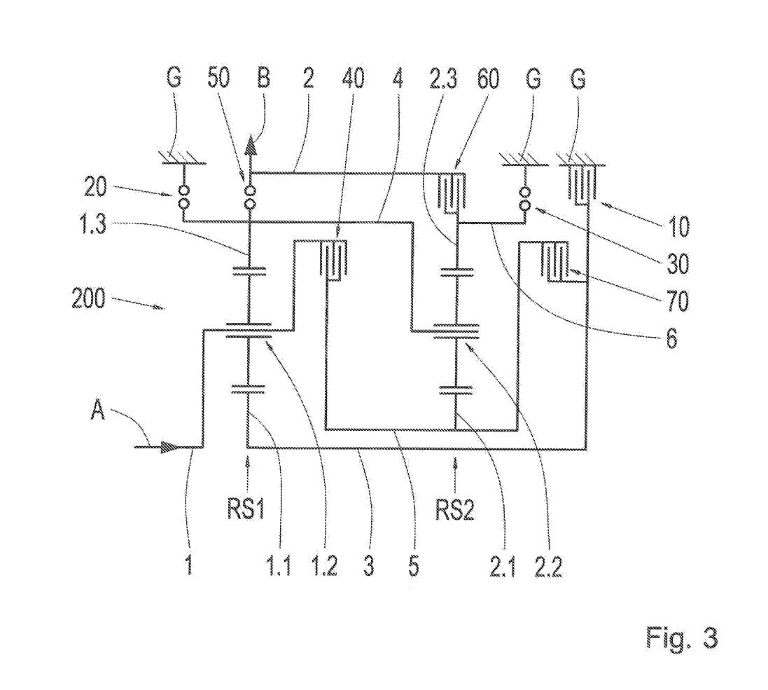

FIG. 3 shows a further possible embodiment of a powershift-capable multi-stage transmission 200. Components of the multi-stage transmission 200 which are identical or functionally identical to components of the multi-stage transmission 100 as per FIG. 1 are denoted by the same reference designations; in this respect, reference is made to the description relating to the multi-stage transmission 100 as per FIG. 1.

The multi-stage transmission 200 as per FIG. 2 differs from the multi-stage transmission 100 as per FIG. 1 in that the multi-stage transmission 200 is suitable for front-transverse installation or rear-transverse installation in a motor vehicle. For this purpose, the drive shaft 1 and the output shaft 2 are arranged axially offset with respect to one another. The arrangement of the planetary gear sets RS1 and RS2 relative to one another is preferably such that, in an axial direction with respect to the drive shaft 1 and proceeding from the drive shaft 1, the sequence first planetary gear set RS1, second planetary gear set RS2 is provided.

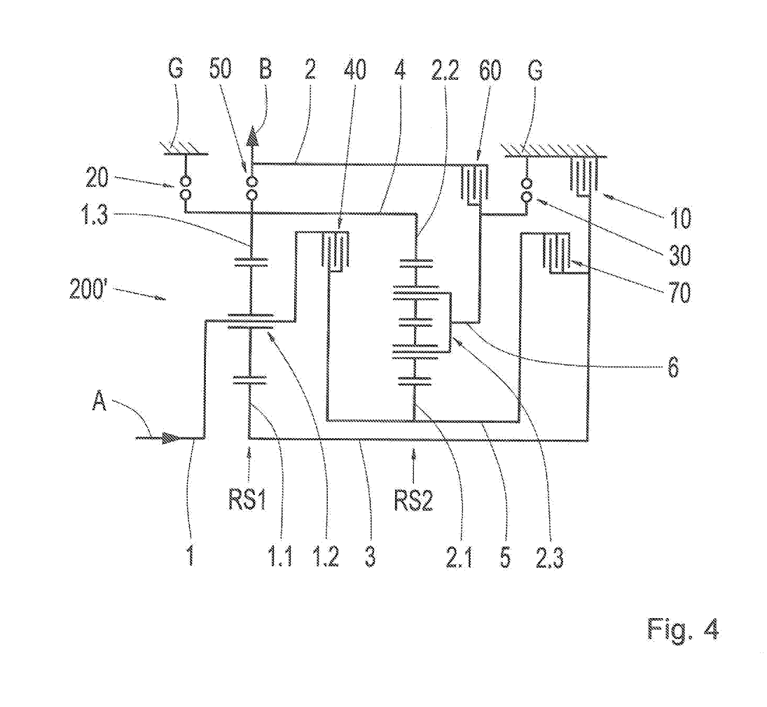

FIG. 4 shows a multi-stage transmission 200′ which is modified in relation to the multi-stage transmission 200 as per FIG. 3. The modification consists in that the multi-stage transmission 200′ as per FIG. 4 has a planetary gear set which is a plus transmission or plus planetary gear set. In the multi-stage transmission 200′ as per FIG. 4, the second planetary gear set RS2 is a plus transmission. In this case, the first transmission element 2.1 is a sun gear, the second transmission element 2.2 is a ring gear, and the third transmission element 2.3 is a planet gear carrier, particularly a carrier. The first planetary gear set RS1 is—as in the multi-stage transmission 200 as per FIG. 3—a minus transmission. There, the first transmission element 1.1 is a sun gear, the second transmission element 1.2 is a planet gear carrier, particularly a carrier, and the third transmission element 1.3 is a ring gear.

The multi-stage transmissions 100, 200 and 200′ described in the above figures may be operated in accordance with the engagement sequence matrix as per FIG. 2 and as described above with regard to FIG. 1.

The multi-stage transmissions 100, 200 and 200′ have in each case two planetary gear sets and seven shift elements, of which three shift elements are utilized as brakes and the remaining four shift elements are utilized as clutches and of which in each case three shift elements must be shifted simultaneously in order to engage a gear ratio. Furthermore, the multi-stage transmissions 100, 200 and 200′ each have six forward gear ratios and one reverse gear ratio.

Modifications and variations can be made to the embodiments illustrated or described herein without departing from the scope and spirit of the invention as set forth in the appended claims.

### REFERENCE DESIGNATIONS

1 Drive shaft (first shaft)
2 Output shaft (second shaft)
3 Third shaft
4 Fourth shaft
5 Fifth shaft
6 Sixth shaft
RS1 First planetary gear set
RS2 Second planetary gear set
1.1 First transmission element of the first planetary gear set
1.2 Second transmission element of the first planetary gear set
1.3 Third transmission element of the first planetary gear set
2.1 First transmission element of the second planetary gear set
2.2 Second transmission element of the second planetary gear set
2.3 Third transmission element of the second planetary gear set
10 First shift element
20 Second shift element
30 Third shift element
40 Fourth shift element
50 Fifth shift element
60 Sixth shift element
70 Seventh shift element
100 Multi-stage transmission
200 Multi-stage transmission
200 Multi-stage transmission
G Housing, component fixed with respect to a housing
A Arrow
B Arrow

1-16. (canceled)

17. A powershift-capable multi-stage transmission of planetary design, in particular for a combustion-engine-powered and/or electric-motor-powered drive of a motor vehicle, having gear ratio stages for multiple forward gear ratios and a reverse gear ratio, comprising:
a drive shaft (1) which is also a first shaft;
an output shaft (2) which is also a second shaft;
two planetary gear sets (RS1, RS2) which are coupled or coupleable to one another and which each have at least a first transmission element (1.1, 2.1), a second transmission element (1.2, 2.2) and a third transmission element (1.3, 2.3); and
multiple shift elements (10, 20, 30, 40, 50, 60, 70) which are assigned to the planetary gear sets (RS1, RS2) and the selective shifting of which gives rise to a transmission ratio, corresponding to the respective gear ratio stages, between the drive shaft (1) and the output shaft (2),
wherein at least three of the shift elements (10, 20, 30, 40, 50, 60, 70) are brakes by which the first transmission element (1.1, 2.1), the second transmission element (1.2, 2.2) or the third transmission element (1.3, 2.3) of the planetary gear sets (RS1, RS2) can be braked directly or indirectly against a component (G) fixed with respect to a housing.

18. The multi-stage transmission of claim 17, wherein three of the shift elements (10, 20, 30, 40, 50, 60, 70) are closed in each of the multiple forward gear ratio stages and the reverse gear ratio.

19. The multi-stage transmission of claim 17, wherein:
the first transmission element (1.1) of the first planetary gear set (RS1) is connected rotationally fixedly to a third shaft (3), the second transmission element (1.2) of the first planetary gear set (RS1) is connected rotationally fixedly to the drive shaft (1) and the third transmission element (1.3) of the first planetary gear set (RS1) is connected rotationally fixedly to a fourth shaft (4); and
the first transmission element (2.1) of the second planetary gear set (RS2) is connected rotationally fixedly to a fifth shaft (5), the second transmission element (2.2) of the second planetary gear set (RS2) is connected rotationally fixedly to the fourth shaft (4) and the third transmission element (2.3) of the second planetary gear set (RS2) is connected rotationally fixedly to a sixth shaft (6).

20. The multi-stage transmission of claim 19, wherein:
the third shaft (3) is connectable by a first shift element (10) of the shift elements (10, 20, 30, 40, 50, 60, 70) to the component (G) fixed with respect to a housing;
the fourth shaft (4) is operatively connectable by a second shift element (20) of the shift elements (10, 20, 30, 40, 50, 60, 70) to the component (G) fixed with respect to the housing;
the sixth shaft (6) is operatively connectable by a third shift element (30) of the shift elements (10, 20, 30, 40, 50, 60, 70) to the component (G) fixed with respect to the housing;
the drive shaft (1) is operatively connectable by a fourth shift element (40) of the shift elements (10, 20, 30, 40, 50, 60, 70) to the fifth shaft (5);
the output shaft (2) is operatively connectable by a fifth shift element (50) of the shift elements (10, 20, 30, 40, 50, 60, 70) to the fourth shaft (4) and/or by a sixth shift element (60) of the shift elements (10, 20, 30, 40, 50, 60, 70) to the sixth shaft (6); and
the third shaft (3) is operatively connectable by a seventh shift element (70) of the shift elements (10, 20, 30, 40, 50, 60, 70) to the fifth shaft (5).

21. The multi-stage transmission of claim 20, wherein:
six forward gear ratios are selectively engageable;
the third shift element (30), the fourth shift element (40) and the fifth shift element (50) are closed in a first forward gear ratio of the six forward gear ratios;
the third shift element (30), the fifth shift element (50) and the seventh shift element (70) are closed in a second forward gear ratio of the six forward gear ratios;
the fourth shift element (40), the fifth shift element (50) and the seventh shift element (70) are closed in a third forward gear ratio of the six forward gear ratios;
the first shift element (10), the fourth shift element (40) and the fifth shift element (50) are closed in a fourth forward gear ratio of the six forward gear ratios;
the first shift element (10), the fourth shift element (40) and the sixth shift element (60) are closed in a fifth forward gear ratio of the six forward gear ratios; and
the first shift element (10), the sixth shift element (60) and the seventh shift element (70) are closed in a sixth forward gear ratio of the six forward gear ratios.

22. The multi-stage transmission of claim 20, wherein one reverse gear ratio is selectively engageable, the second shift element (20), the fourth shift element (40) and the sixth shift element (60) being closed in the one reverse gear ratio.

23. The multi-stage transmission of claim 20, wherein one or more of the second shift element (20), the third shift element (30) and the fifth shift element (50) is a dog-clutch shift element.

24. The multi-stage transmission of claim 20, wherein the second shift element (20) and the third shift element (30) collectively form a common positively locking double shift element.

25. The multi-stage transmission of claim 20, wherein the second shift element (20) and the fifth shift element (50) collectively form a common positively locking double shift element.

26. The multi-stage transmission of claim 17, wherein the first transmission element (1.1, 2.1) is a sun gear, the second transmission element (1.2, 2.2) is a planet gear carrier, and the third transmission element (1.3, 2.3) is a ring gear in each of the planetary gear sets (RS1, RS2).

27. The multi-stage transmission of claim 17, wherein at least one of the planetary gear sets (RS1, RS2) is a plus planetary gear set.

28. The multi-stage transmission of claim 27, wherein the second planetary gear set (RS2) is the plus planetary gear set, the first transmission element (2.1) of the second planetary gear set (RS2) is a sun gear, the second transmission element (2.2) of the second planetary gear set (RS2) is a ring gear, and the third transmission element (2.3) of the second planetary gear set (RS2) is a planet gear carrier.

29. The multi-stage transmission of claim 17, wherein the fourth shift element (40) is utilizable as a launch element.

30. The multi-stage transmission of claim 19, wherein the third shaft (3), the fourth shaft (4), the fifth shaft (5), or the sixth shaft (6) is utilizable as a further drive shaft, the further drive shaft operatively connectable by a separating clutch to a further drive.

31. A powershift-capable multi-stage transmission of planetary design, in particular for a combustion-engine-powered and/or electric-motor-powered drive of a motor vehicle, having gear ratio stages for multiple forward gear ratios and a reverse gear ratio, comprising:
a drive shaft (1) which is also a first shaft;
an output shaft (2) which is also a second shaft;
two planetary gear sets (RS1, RS2) which are coupled or coupleable to one another and which each have at least a first transmission element (1.1, 2.1), a second transmission element (1.2, 2.2) and a third transmission element (1.3, 2.3); and
multiple shift elements (10, 20, 30, 40, 50, 60, 70) which are assigned to the planetary gear sets (RS1, RS2) and the selective shifting of which gives rise to a transmission ratio, corresponding to the respective gear ratio stages, between the drive shaft (1) and the output shaft (2),
wherein at least two of the shift elements (10, 20, 30, 40, 50, 60, 70) are dog-clutch shift elements.

32. The multi-stage transmission of claim 31, wherein at least three of the shift elements (10, 20, 30, 40, 50, 60, 70) are brakes by which the first transmission element (1.1, 2.1), the second transmission element (1.2, 2.2) or the third transmission element (1.3, 2.3) of the planetary gear sets (RS1, RS2) can be braked directly or indirectly against a component (G) fixed with respect to a housing.

33. The multi-stage transmission of claim 31, wherein three of the shift elements (10, 20, 30, 40, 50, 60, 70) are closed in each of the multiple forward gear ratio stages and the reverse gear ratio.

34. The multi-stage transmission of claim 31, wherein:
the first transmission element (1.1) of the first planetary gear set (RS1) is connected rotationally fixedly to a third shaft (3), the second transmission element (1.2) of the first planetary gear set (RS1) is connected rotationally fixedly to the drive shaft (1) and the third transmission element (1.3) of the first planetary gear set (RS1) is connected rotationally fixedly to a fourth shaft (4); and
the first transmission element (2.1) of the second planetary gear set (RS2) is connected rotationally fixedly to a fifth shaft (5), the second transmission element (2.2) of the second planetary gear set (RS2) is connected rotationally fixedly to the fourth shaft (4) and the third transmission element (2.3) of the second planetary gear set (RS2) is connected rotationally fixedly to a sixth shaft (6).

35. The multi-stage transmission of claim 34, wherein:
the third shaft (3) is operatively connectable by a first shift element (10) of the shift elements (10, 20, 30, 40, 50, 60, 70) to a component (G) fixed with respect to a housing;
the fourth shaft (4) is operatively connectable by a second shift element (20) of the shift elements (10, 20, 30, 40, 50, 60, 70) to the component (G) fixed with respect to the housing;
the sixth shaft (6) is operatively connectable by a third shift element (30) of the shift elements (10, 20, 30, 40, 50, 60, 70) to the component (G) fixed with respect to the housing;
the drive shaft (1) is operatively connectable by a fourth shift element (40) of the shift elements (10, 20, 30, 40, 50, 60, 70) to the fifth shaft (5);
the output shaft (2) is operatively connectable by a fifth shift element (50) of the shift elements (10, 20, 30, 40, 50, 60, 70) to the fourth shaft (4) and/or by a sixth shift element (60) of the shift elements (10, 20, 30, 40, 50, 60, 70) to the sixth shaft (6); and
the third shaft (3) is operatively connectable by a seventh shift element (70) of the shift elements (10, 20, 30, 40, 50, 60, 70) to the fifth shaft (5).

36. The multi-stage transmission of claim 35, wherein:
six forward gear ratios are selectively engageable;
the third shift element (30), the fourth shift element (40) and the fifth shift element (50) are closed in a first forward gear ratio of the six forward gear ratios;
the third shift element (30), the fifth shift element (50) and the seventh shift element (70) are closed in a second forward gear ratio of the six forward gear ratios;
the fourth shift element (40), the fifth shift element (50) and the seventh shift element (70) are closed in a third forward gear ratio of the six forward gear ratios;
the first shift element (10), the fourth shift element (40) and the fifth shift element (50) are closed in a fourth forward gear ratio of the six forward gear ratios;
the first shift element (10), the fourth shift element (40) and the sixth shift element (60) are closed in a fifth forward gear ratio of the six forward gear ratios; and
the first shift element (10), the sixth shift element (60) and the seventh shift element (70) are closed in a sixth forward gear ratio of the six forward gear ratios.

37. The multi-stage transmission of claim 35, wherein one reverse gear ratio is selectively engageable, the second shift element (20), the fourth shift element (40) and the sixth shift element (60) being closed in the one reverse gear ratio.

38. The multi-stage transmission of claim 35, wherein one or more of the second shift element (20), the third shift element (30) and the fifth shift element (50) is a dog-clutch shift element.

39. The multi-stage transmission of claim 35, wherein the second shift element (20) and the third shift element (30) collectively form a common positively locking double shift element.

40. The multi-stage transmission of claim 35, wherein the second shift element (20) and the fifth shift element (50) collectively form a common positively locking double shift element.

41. The multi-stage transmission of claim 31, wherein the first transmission element (1.1, 2.1) is a sun gear, the second transmission element (1.2, 2.2) is a planet gear carrier, and the third transmission element (1.3, 2.3) is a ring gear in each of the planetary gear sets (RS1, RS2).

42. The multi-stage transmission of claim 31, wherein at least one of the planetary gear sets (RS1, RS2) is a plus planetary gear set.

43. The multi-stage transmission of claim 42, wherein the second planetary gear set (RS2) is the plus planetary gear set, the first transmission element (2.1) of the second planetary gear set (RS2) is a sun gear, the second transmission element (2.2) of the second planetary gear set (RS2) is a ring gear, and the third transmission element (2.3) of the second planetary gear set (RS2) is a planet gear carrier.

44. The multi-stage transmission of claim 31, wherein the fourth shift element (40) is utilizable as a launch element.

45. The multi-stage transmission of claim 34, wherein the third shaft (3), the fourth shaft (4), the fifth shaft (5), or the sixth shaft (6) is utilizable as a further drive shaft, the further drive shaft operatively connectable by a separating clutch to a further drive.
